(19) United States
(12) Patent Application Publication
(10) Pub. No.: US 2009/0188442 A1
(43) Pub. Date: Jul. 30, 2009

(54) Decorative Accessories for Pets

(76) Inventor: Angela Dawe, Vero Beach, FL (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/362,426

(22) Filed: Jan. 29, 2009

Related U.S. Application Data
(60) Provisional application No. 61/024,375, filed on Jan. 29, 2008.

(51) Int. Cl. A01K 27/00; B68B 1/00

(52) U.S. Cl. 119/792; 119/858; 119/795; 54/12

(57) ABSTRACT

A decorative accessory for a pet includes a harnessing member, a leash member, and a plurality of charm elements. The harnessing member includes at least one strap element, each having a plurality of engagement locations, and a fastening element. The plurality of engagement locations is configured on the each strap element. The fastening element is disposed on the each strap element. The leash member includes a strip element having a first end segment and a second end segment, a plurality of engagement emplacements configured on the strip element, and a connecting element disposed at the first end segment for connecting the leash member with the harnessing member. Each charm element of the plurality of charm elements includes an attaching mechanism having a female engagement element and a male engagement element adapted to secure the each charm element to at least one of the harnessing member and the leash member.

### CROSS-REFERENCE TO RELATED APPLICATIONS

The present invention claims priority under 35 United States Code, Section 119 on the U.S. Provisional Patent Application No. 61/024,375 filed on Jan. 29, 2008, the disclosure of which is incorporated by reference.

### FIELD OF THE INVENTION

The present invention generally relates to pets accessories, and, more particularly, to a decorative accessory, such as a decorative harness and a decorative leash to be worn by and/or used with a pet, such as a dog, a cat, a horse, a pig, a cow, a donkey, a mule, a camel, a sheep, and the like.

### BACKGROUND OF THE INVENTION

Generally, pets, such as dogs, cats, horses, pigs, cows, donkeys, mules, camels, and sheep are known to be useful members of society. Pets have been proved to be honored companions and symbols of status for individuals. The individuals keeping the pets will be hereinafter referred be to as pet owners. Pets are usually controlled and identified by the pet owners by means of various accessories, such as a harness (also sometimes referred to as a collar or tack), a leash and the like. Typically, a harness may include one or more straps that may be secured to a body portion of the pet for providing a handle means to grab the pet. Further, a leash is a long strip that may be tied to the harness for controlling and restraining the pet. The harness and the leash may be made of a fabric, a fiber, and/or a rubber material. In general, various accessories, such as the harness and the leash are used collectively for handling the pet. Moreover, these accessories enable the pet owners to identify their pets by the harness and/or the leash worn by the pets.

Apart from providing control and identification of the pets, the currently available accessories, such as the harness and the leash, impart style to the pets. These days, pet owners prefer accessories having decorative embellishments and adorning items thereon for their pets. The accessories having decorative embellishments and adorning items thereon may be hereinafter referred to as decorative accessories. Specifically, the decorative accessories impart style to the pets. Further, such decorative accessories may serve as status symbols for the pet owners.

Typically, the decorative accessories, such as decorative harnesses and decorative leashes (also referred to as decorative harness/leash), are available in various colors. Further, such decorative accessories include decorative embellishments configured on conventional accessories such as harnesses and leashes. Presently, decorative embellishments such as precious and semi-precious stones, antique beads, pearls, and crystals are attached to the strap/strip of the harness/leash for decoration thereof. Typically, such decorative embellishments are attached to the strap/strip of the harness/leash by means of a hook and loop arrangement. However, with time, the hook and loop arrangement may get worn out due to excessive use thereof, thereby impacting attachment of the decorative embellishments with the strap/strip. For example, the wearing out of such hook and loop arrangement may result in loosening and/or missing of the decorative embellishments from the strap/strip. Further, for maintaining hygiene, the hook and loop arrangement is required to be cleaned on a regular basis, which may be a tedious and time consuming chore.

Other conventional methods/techniques for attaching such decorative embellishments to the strap/strip of the decorative harness/leash include gluing, and/or stitching the embellishments thereto. However, such conventional methods/techniques are also usually ineffective in attaching the decorative embellishments to the strap/strip of the decorative harness/leash for a longer duration of time, and involve a high risk of loosening and/or detaching the decorative embellishments from the decorative harness/leash.

Accordingly, there exists a need of a decorative accessory, such as a decorative harness and a decorative leash for a pet that may incorporate decorative embellishments into structures thereof in a sturdy manner, and allows a pet owner to decorate his/her pet that provide visible evidence of status and value of the pet.

### SUMMARY OF THE INVENTION

In view of the foregoing disadvantages inherent in the prior-art, the general purpose of the present invention is to provide a decorative accessory for a pet, to include all advantages of the prior art, and to overcome the drawbacks inherent in the prior art.

An object of the present invention is to provide a decorative accessory, such as a decorative harness and a decorative leash for a pet that may incorporate decorative materials, such as various shapes and types of charms, which may include, but are not limited to, heart shaped charms, star shaped charms, alphabet shaped charms, number shaped charms, and the like, into structures thereof in a sturdy manner.

Another object of the present invention is to provide a decorative accessory, such as a decorative harness and a decorative leash for a pet that allows a pet owner to decorate his/her pet, which in turn may provide visible evidence of status of the pet owner, and visible evidence of value of the pet.

In light of the above objects, in an aspect of the present invention, a decorative accessory for a pet is provided. The decorative accessory comprises a harnessing member, a leash member, and a plurality of charm elements. The harnessing member includes at least one strap element. Each strap element of the at least one strap element include a plurality of engagement locations, and a fastening element. The plurality of engagement locations is configured on the each strap element. The fastening element is disposed on the each strap element for securing the harnessing member to a body portion of the pet. Further, the leash member includes a strip element, a plurality of engagement emplacements, and a connecting element. The strip element includes a first end segment and a second end segment. The plurality of engagement emplacements is configured on the strip element between the first end segment and the second end segment. The connecting element is disposed at the first end segment for connecting the leash member with the harnessing member. Furthermore, each charm element of the plurality of charm elements includes an attaching mechanism extending from an underside of the each charm element. The attaching mechanism includes a female engagement element and a male engagement element. The female engagement element and the male engagement element are adapted to secure the each charm element to at least one of an engagement location of the plurality of engagement locations of the at least one strap element, and an engagement emplacement of the plurality of engagement emplacements of the strip element, thereby securing the each charm element of the plurality of charm elements on least one of the harnessing member and the leash member.

According to another aspect of the present invention, a decorative harness for being configured to a body portion of a pet is provided. The decorative harness comprises a harnessing member and a plurality of charm elements. The harnessing member includes at least one strap element. Each strap element of the at least one strap element include a plurality of engagement locations, and a fastening element. The plurality of engagement locations is configured on the each strap element. The fastening element is disposed on the each strap element for securing the harnessing member to a body portion of the pet. Further, each charm element of the plurality of charm elements includes an attaching mechanism extending from an underside of the each charm element. The attaching mechanism includes a female engagement element and a male engagement element. The female engagement element and the male engagement element are adapted to secure the each charm element to an engagement location of the plurality of engagement locations of the at least one strap element, thereby securing the each charm element of the plurality of charm elements on the harnessing member.

According to further aspect of the present invention, a decorative leash for being connected to a harnessing member for retaining a pet is provided. The decorative leash comprises a leash member and a plurality of charm elements. The leash member includes a strip element, a plurality of engagement and a connecting element. The strip element includes a first end segment and a second end segment. The plurality of engagement emplacements is configured on the strip element between the first end segment and the second end segment. The connecting element is disposed at the first end segment. The connecting element is capable of connecting the leash member to the harnessing member for retaining the pet. Further, each charm element of the plurality of charm elements includes an attaching mechanism extending from an underside of the each charm element. The attaching mechanism includes a female engagement element and a male engagement element. The female engagement element and the male engagement element are adapted to secure the each charm element to an engagement emplacement of the plurality of engagement emplacements of the strip element, thereby securing the each charm element of the plurality of charm elements on the leash member.

The decorative accessory, such as the decorative harness and the decorative leash, as disclosed above, allows a pet owner to decorate his/her pet, which in turn provides visible evidence of status of the pet owner, and visible evidence of value of the pet. The each charm element of the plurality of charm elements may be secured on the harnessing member and the leash member in a sturdy manner. More particularly, the each charm element may be secured on the harnessing member and the leash member in the sturdy manner by the attaching mechanism extending from the underside of the each charm element. The attaching mechanism of the each charm element includes the female engagement element and the male engagement element, which facilitates the each charm element to be secured on the harnessing member and the leash member in the sturdy manner.

These together with the other aspects of the present invention, along with the various features of novelty that characterized the present invention, are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of a decorative accessory worn by and/or used with a pet, such as a dog, according to an exemplary embodiment of the present invention;

FIG. 2 illustrates a perspective view of the decorative accessory of FIG. 1 in a disassembled manner, according to an exemplary embodiment of the present invention;

FIG. 3A illustrates a perspective view of a decorative harness, according to an exemplary embodiment of the present invention;

FIG. 3B illustrates a perspective view a decorative leash, according to an exemplary embodiment of the present invention;

FIGS. 4A to 4E illustrate front views of various types of charm elements to be used in conjunction with at least a harnessing member and a leash member, according to an exemplary embodiment of the present invention;

FIG. 5A illustrate exploded views of an attaching mechanism incorporated in a charm element of various types of the charm elements of FIGS. 4A to 4E, according to an exemplary embodiment of the present invention;

FIG. 5B illustrate exploded view of an attaching mechanism incorporated in a charm element of various types of the charm elements of FIGS. 4A to 4E, according to another exemplary embodiment of the present invention;

FIG. 6A illustrates a perspective view of a charm element being attached to a harnessing member, according to an exemplary embodiment of the present invention;

FIG. 6B illustrates a perspective view of a charm element being attached to a harnessing member, according to another exemplary embodiment of the present invention; and

FIG. 7 illustrates a perspective view of a decorative harness worn by and/or used with a pet, such as a horse, according to another embodiment the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The term “first,” “second,” and the like, herein do not denote any order, elevation or importance, but rather are used to distinguish placement of one element over another. The terms “a” and “an” herein do not denote a limitation of quantity, but rather denote the presence of at least one of the referenced item.

The present invention provides a decorative accessory for a pet that allows a pet owner to decorate his/her pet. The decorative accessory may be worn by and/or used with the pet, such as a dog, a cat, a horse, and the like. The decorative accessory includes a decorative harness, and a decorative leash. Specifically, the decorative accessory includes a harnessing member, a leash member, and a plurality of charm elements for decorating the harnessing member, and the leash member. The plurality of charm elements is secured on the harnessing member and the leash member in a sturdy manner by an attaching mechanism configured on each charm elements of the plurality of charm elements. Further, the decorative accessory provides visible evidence of status of the pet owner, and visible evidence of value of the pet.

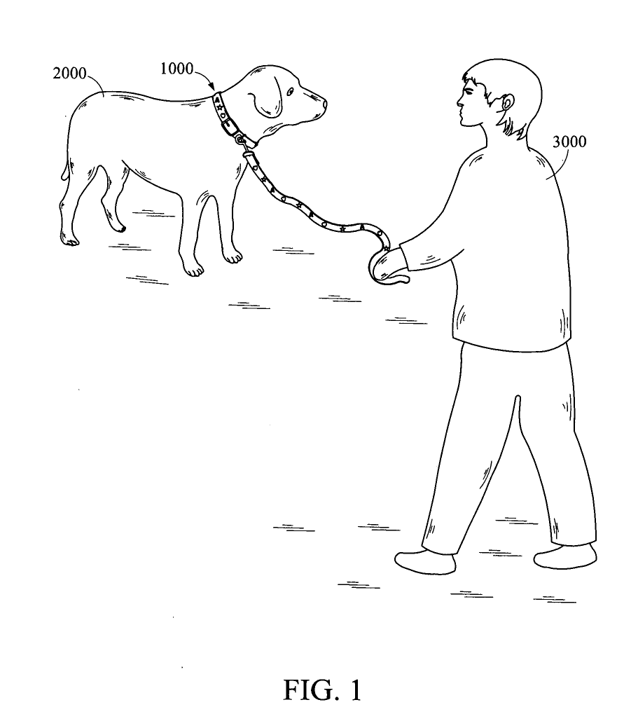

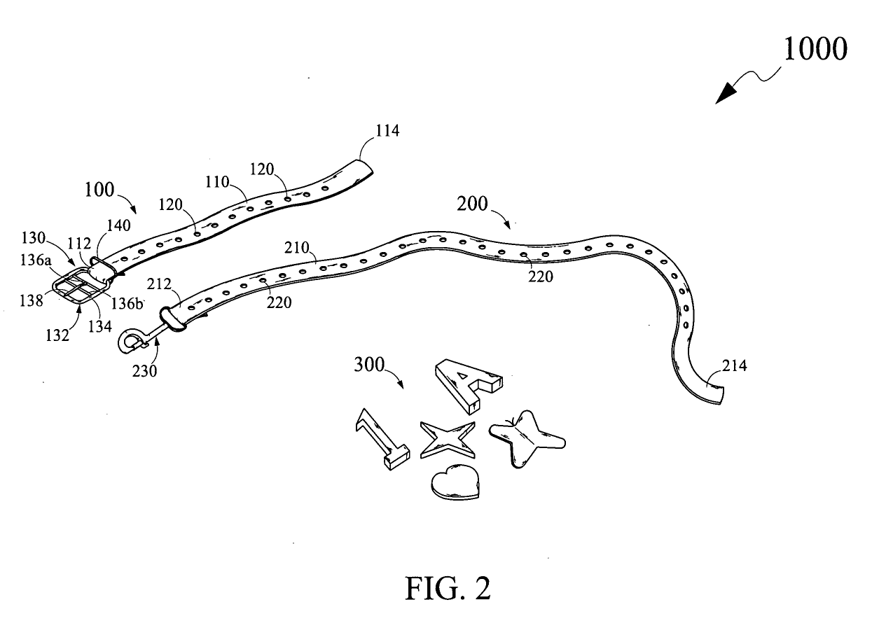

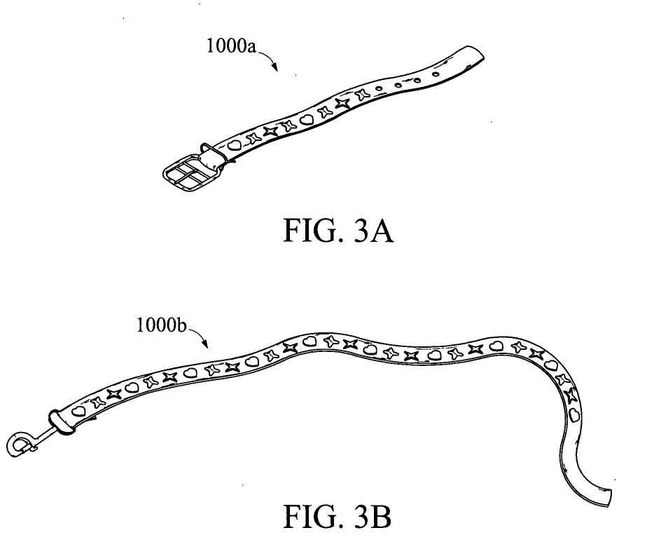

Referring now to FIGS. 1, 2, 3A and 3B, a decorative accessory 1000 is illustrated, according to an embodiment of the present invention. Specifically, FIG. 1 illustrates a perspective view of the decorative accessory 1000 worn by and/or used with a pet 2000, and FIG. 2 illustrates a perspective view of the decorative accessory 1000 of FIG. 1 in a disassembled manner. The decorative accessory 1000 includes a harnessing member 100, a leash member 200, and a plurality of charm elements, such as charm elements 300. The charm elements 300 may be attached to the harnessing member 100 to decorate the harnessing member 100 for configuring a decorative harness. Such decorative harness is explained further in conjunction with FIG. 3A as a decorative harness 1000a. Further, the charm elements 300 may be attached to the leash member 200 to decorate the leash member 200 for configuring a decorative leash. Such decorative leash is explained further in conjunction with FIG. 3B as a decorative leash 1000b.

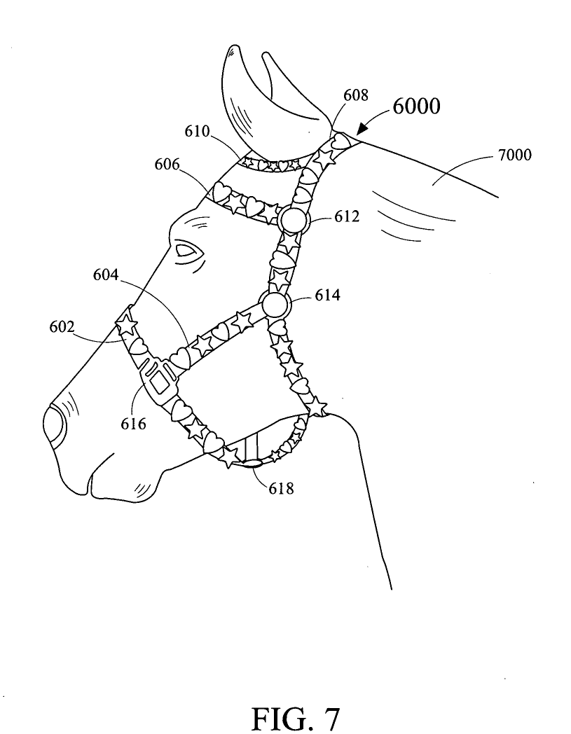

As shown in FIG. 1, the decorative harness 1000a is adapted to be secured to a body portion of the pet 2000, such as a dog. The present embodiment is explained with reference to a dog, however, it will evident to a person skilled in the art that the decorative harness 1000a may be secured to a body portion of other pets also, such as a cat, a horse, a pig, a cow, a donkey, a mule, a camel, and a sheep. Accordingly, in another exemplary embodiment of the present invention, a decorative harness is configured to be worn and/or used with a pet, such as a horse, which will be explained further in conjunction with FIG. 7.

Further, the decorative leash 1000b may be connected to the decorative harness 1000a. A portion (not numbered) of the decorative leash 1000b may be gripped by a pet owner 3000 to retain the pet 2000 within a desired region. The decorative accessory 1000 allows the pet owner 3000 to decorate his/her pet, such as the pet 2000. Further, the decorative accessory 1000 provides visible evidence of status of the pet owner 3000, and visible evidence of value of the pet 2000.

Specifically, referring to FIG. 2, the harnessing member 100 includes at least one strap element, such as a strap element 110, may be worn by and/or used with the pet 2000. Example of the decorative harness having the harnessing member with one strap element includes, but is not limited to, a decorative collar. The decorative collar may be worn by and/or used with pets, such as, a dog, a cat, and the like. In another embodiment of the present invention, the harnessing member of the disclosed decorative harness includes a plurality of straps. Examples of the decorative harness having the harnessing member with the plurality of strap elements includes, but are not limited to, a chest collar, a halter, and a headstall. Such harnessing members having the plurality of straps may be worn by and/or used with pets, such as, a horse, a mule, a goat, a camel, a llama, and a yak. The harnessing member having the plurality of strap elements will be explained further in conjunction with FIG. 7.

Referring back to FIG. 2, the strap element 110 includes a plurality of engagement locations, such as engagement locations 120, and a fastening element 130. Further, the strap element 110 includes a first end portion 112 and a second end portion 114. Further, the engagement locations 120 are configured on the strap element 110 between the first end portion 112 and the second end portion 114. According to one embodiment of the present invention, the engagement locations 120 are through holes configured on the strap element 110 between the first end portion 112 and the second end portion 114 in a manner such that adjacent engagement locations 120 are spaced apart by a predetermined distance. The predetermined distance of adjacent engagement locations 120 may be selected as per requirement. Furthermore, the fastening element 130 is disposed at the first end portion 112 of the strap element 110 for securing the harnessing member 100 to the body portion of the pet 2000. According to one embodiment of the present invention, the harnessing member 100 may be held around the neck portion of the pet 2000 (as shown in FIG. 1) by connecting the first end portion 112 and the second end portion 114 by the fastening element 130.

Further, according to one embodiment of the present invention, the fastening element 130 includes a fastening buckle 132. The fastening buckle 132 is disposed at the first end portion 112. More particularly, the fastening buckle 132 includes a rim 134, at least two center bars, such as a bar 136a and a bar 136b, and a hook element 138. The first end portion 112 of the strap element 110 incorporates a portion of the rim 134, thereby attaching the fastening buckle 132 to the strap element 110. Further, the bar 136a and the bar 136b are spaced apart, and disposed on the rim 134. Furthermore, the hook element 138 is pivotally coupled to the bar 136a. Alternatively, the hook element 138 may be pivotally coupled to the bar 136b instead of the bar 136a. In this alternate embodiment, the first end portion 112 of the strap element may incorporate a portion of the bar 136a.

The fastening element 130 enables the harnessing member 100 to be secured to the body portion of the pet 2000 (such as the dog and the cat). For securing the harnessing member 100 to the body portion of the pet 2000, the second end portion 114 of the strap element 110 is adapted to pass through the rim 134 disposed at the first end portion 112. Further, the hook element 138 is inserted into an engagement location of the engagement locations 120 for locking the harnessing member 100 in position. Further, the fastening element 130 includes a slack ring element 140 disposed at the first end portion 112 adjacent to the fastening buckle 132. The slack ring element 140 is capable of engaging the second end portion 114 that passed through the rim 134, thereby engaging the second end portion 114 in a sturdy manner. Accordingly, the slack ring element 140 prevents the second end portion 114 from flapping. As explained herein, the fastening element 130 enables the strap element 110 to be firmly secured to the neck portion of the pet 2000.

The strap element 110 of the harness member 100 may be sufficiently long for being secured to a body portion (for example, to a neck portion) of a pet, such as the pet 2000. According to one embodiment of the present invention, the strap element 110 may be made of a material including, but not limiting to, nylon, leather, faux leather (PVC). The strap element 110 of such material provides comfort to the body portion of the pet 2000. Further, the strap element 110 may be made in variety of colors selected from a wide range of colors, such as red, yellow, green, depending upon preferences of the pet owner 3000. According to one embodiment of the present invention, the fastening element 130 of the harnessing member 100 may be made of a material including, but not limiting to, nickel, brass, zinc, stainless steel, and the like.

As disclosed herein, the decorative accessory 1000 includes the leash member 200. The leash member 200 comprises a strip element 210, similar to the strap element 110 but of longer length, a plurality of engagement emplacements, such as engagement emplacements 220, similar to the engagement locations 120, and a connecting element 230. The strip element 210 includes a first end segment 212 and a second end segment 214. Further, the engagement emplacements 220 are configured on the strip element 210 between the first end segment 212 and the second end segment 214. According to one embodiment of the present invention, the engagement emplacements 220, similar to the engagement locations 120, are through holes configured on the strip element 210 between the first end segment 212 and the second end segment 214 in a manner such that adjacent engagement emplacements 220 are spaced apart by a predetermined distance. The predetermined distance of adjacent engagement emplacements 220 may be selected as per requirement. Furthermore, the connecting element 230 is disposed at the first end segment 212 for connecting the leash member 200 to the harnessing member 100 (as shown in FIG. 1).

According to one embodiment of the present invention, the connecting element 230 may be a clasp, as known in the art. The leash member 200 may be attached to the harnessing member 100 in a same manner as a standard leash is attached to a standard harnessing member (such as a collar). According to one embodiment of the present invention, the leash member 200 may be attached to the harnessing member 100 by engaging the connecting element 230 to the slack ring element 140 (as shown in FIG. 1). The leash member 200, upon being attached to the harnessing member 100 enables the pet owner 3000 to retain the pet 2000 within a specific region. More particularly, the specific region may be a region covered by a length of the leash member 200. According to one embodiment of the present invention, the length of the leash member 200 may be selected according to a preference of the pet owner 3000. According to one embodiment of the present invention, the leash member 200 may include a loop element (not shown) configured at the second end segment 214 of the strip element 210 for enabling a user, such as the pet owner 3000 to grip the leash member 200 for retaining the pet 2000 within the specific region.

According to one embodiment of the present invention, the strip element 210 of the leash member 200, similar to the strap element 110, may be made of a material including, but not limiting to, nylon, leather, faux leather (PVC). Further, the strip element 210, similar to the strap element 110, may be made in variety of colors selected from a wide range of colors, such as red, yellow, green, depending upon preferences of the pet owner 3000. According to one embodiment of the present invention, the connecting element 230 of the leash member 200 may be made of a material including, but not limiting to, nickel, brass, zinc, stainless steel, and the like.

Further, referring to FIG. 2, the charm elements 300 are capable of being attached to at least one of the harnessing member 100 and the leash member 200. According to one embodiment of the present invention, the charm elements 300 are attached to the harnessing member 100 and the leash member 200, both, thereby configuring the decorative harnessing 1000a and the decorative leash 1000b, respectively, as shown in FIGS. 3A and 3B.

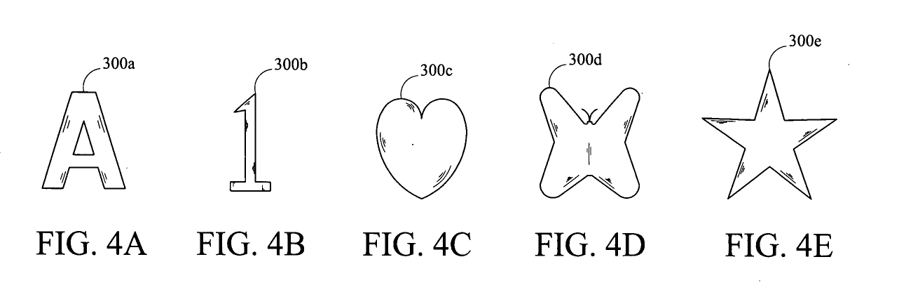

Referring now to FIGS. 4A, 4B, 4C, 4D and 4E, front views of various types of charm elements, such as the charm elements 300 are illustrated, according to one embodiment of the present invention. As shown in FIG. 4A, the charm elements 300 may be letter charm elements, such as a letter charm element 300a. Although, FIG. 4A shows the letter charm element 300a as having a shape of an English letter “A,” it should be clearly understood that the letter charm element 300a may be in a shape of any letter of any language alphabets. Further, as shown in FIG. 4B, the charm elements 300 may be number charm elements, such as a number charm element 300b. Although, FIG. 4B shows the number charm element 300b as having a shape of a number “1,” it should be clearly understood that the number charm element 300b may be in a shape of any number from 0 to 9. Furthermore, as shown in FIGS. 4C to 4E, the charm elements 300 may be design charm elements, such as a design charm element 300c, a design charm element 300d, and a design charm element 300e (herein after also collectively referred to as design charm elements 300c, 300d, 300e). Although FIGS. 4C, 4D, and 4E illustrate the design charm elements 300c, 300d and 300e as having shapes of a heart, a butterfly, and a star, respectively, it should be clearly understood that the design charm elements 300c, 300d and 300e may have any other design shapes.

Charm elements 300, such as the letter charm element 300a, the number charm element 300b, and the design charm elements 300c, 300d and 300e, may be made of a metal including, but not limiting to, a zinc metal with an enamel paint used to color the charm elements, which in turn provides an epoxy enamel coating to the charm elements 300. Further, the charm elements 300 may be made of elastomers, rubbers, plastics, recycled materials, and/or any other durable material that may not rust. The charm elements 300 may be manufactured in a variety of colors, shapes and size. The shape and the size of the charm elements 300 may be determined by thickness, width and length thereof.

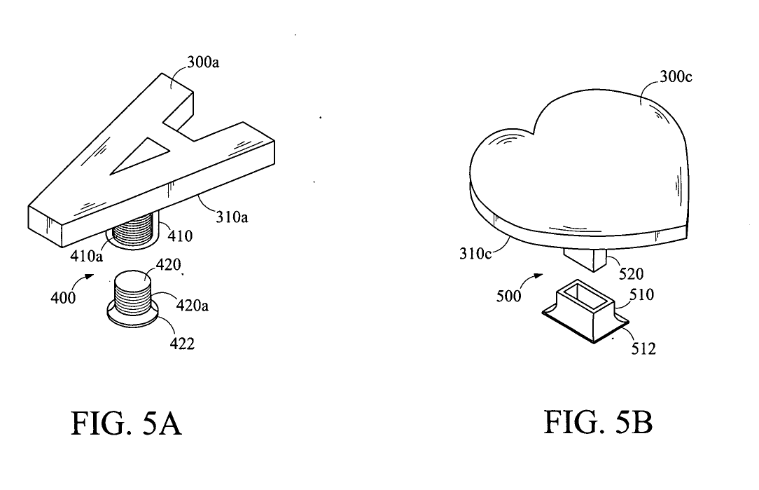

Each charm element, such as the letter charm element 300a, the number charm element 300b, and the design charm elements 300c, 300d and 300e of the charm elements 300 includes an attaching mechanism (not shown) extending from an underside of the each charm element. The attaching mechanism of the charm elements is explained in detail in conjunction with FIGS. 5A and 5B.

Referring now to FIGS. 5A and 5B, exploded views of various types of attaching mechanisms that may be incorporated in the each charm element, such as the letter charm element 300a, the number charm element 300b, and the design charm elements 300c, 300d and 300e are illustrated. More particularly, FIG. 5A illustrates an exploded view of an attaching mechanism incorporated in the letter charm element 300a, according to a first embodiment of the present invention. Further, FIG. 5B illustrates an exploded view of an attaching mechanism incorporated in the design charm element 300c, according to a second embodiment of the present invention. Herein references will be made to previous figures for describing the various types of attaching mechanisms.

For the purpose of description, in FIG. 5A, the letter charm element 300a is shown to include the attaching mechanism, according to the first embodiment of the present invention. Although in the present embodiment, the attachment mechanism is shown as included in the letter charm element 300a, it should be clearly understood that the attaching mechanism may be a part of any other charm element as disclosed above. The letter charm element 300a includes an attaching mechanism 400 extending from an underside 310a of the letter charm element 300a. The attaching mechanism 400 is a screw type attaching mechanism. The attaching mechanism 400 includes a female engagement element 410 and a male engagement element 420. The female engagement element 410 and the male engagement element 420 are adapted to secure the letter charm element 300a to the strap element 110, thereby securing the letter charm element 300a to the harnessing member 100 for configuring the decorative harness 1000a (as shown in FIG. 3A). Further, the female engagement element 410 and the male engagement element 420 are adapted to secure the letter charm element 300a to the strip element 210, thereby securing the letter charm element 300a to the leash member 200 for configuring the decorative leash 1000b (as shown in FIG. 3B).

More particularly, the female engagement element 410 of the attaching mechanism 400 extends from the underside 310a of the letter charm element 300a. The female engagement element 410 of the present embodiment is a threaded female engagement element that includes internal threads 410a. Further, the male engagement element 420 is engaged with the female engagement element 410. The male engagement element 420 of the present embodiment is a threaded male engagement element that includes external threads 420a. Further, the male engagement element 420 includes a head portion 422. The head portion 422 may be a flat shaped head portion, a pigeon shaped head portion, and a Phillips shaped head portion. However, it will be evident to a person skilled in the art to have any other shape of a head portion. The external threads 420a are capable of meshing with the internal threads 410a to engage the male engagement element 420 with the female engagement element 410.

According to one embodiment of the present invention, the attaching mechanism 400 at the threaded male engagement element includes a thread lock compound (not shown) for securing the threaded male engagement element, such as the male engagement element 420 into the threaded female engagement element, such as the female engagement element 410.

Referring now to FIG. 5B to describe the exploded view of an attaching mechanism 500, according the second embodiment of the present invention. For the purpose of description, in FIG. 5B, a design charm element, such as the design charm element 300c is shown to include the attaching mechanism 500. However, it should be clearly understood that an attaching mechanism, such as the attaching mechanism 500 may be configured with a charm element of any shape disclosed above. The design charm element 300c includes the attaching mechanism 500 extending from an underside 310c of the design charm element 300c. The attaching mechanism 500 is a snap fit attaching mechanism. The attaching mechanism 500 includes a female engagement element 510 having a cavity (not numbered) therein, and a male engagement element 520. Further, the female engagement element 510 includes a head portion 512. The head portion 512, similar to the head portion 422, may be a flat shaped head portion, a pigeon shaped head portion, and a Phillips shaped head portion. However, it will be evident to a person skilled in the art to have any other shape of a head portion. The cavity of the female engagement element 510 is adapted to receive the male engagement element 520 for securing the design charm element 300c to the harnessing member 100 to configure the decorative harness 1000a (as shown in FIG. 3A). Further, the female engagement element 510 and the male engagement element 520 are adapted to secure the design charm element 300c to the strip element 210 for securing the design charm element 300c to the leash member 200 to configure the decorative leash 1000b (as shown in FIG. 3B).

More particularly, the male engagement element 520 of the attaching mechanism 500 extends from the underside 310c of the design charm element 300c. The male engagement element 520 is a snap fit male engagement element. Further, the female engagement element 510 is engaged with the male engagement element 520. The female engagement element 510 of the present embodiment is a snap fit female engagement element. The male engagement element 520 and the female engagement element 510 are engaged to each other by press fitting.

The attaching mechanism 400 and 500 may be made of materials including, but not limited to, nickel, stainless steel, brass, zinc plated mild steel, rubber, plastic, recycled materials, and oxidation-resistant materials.

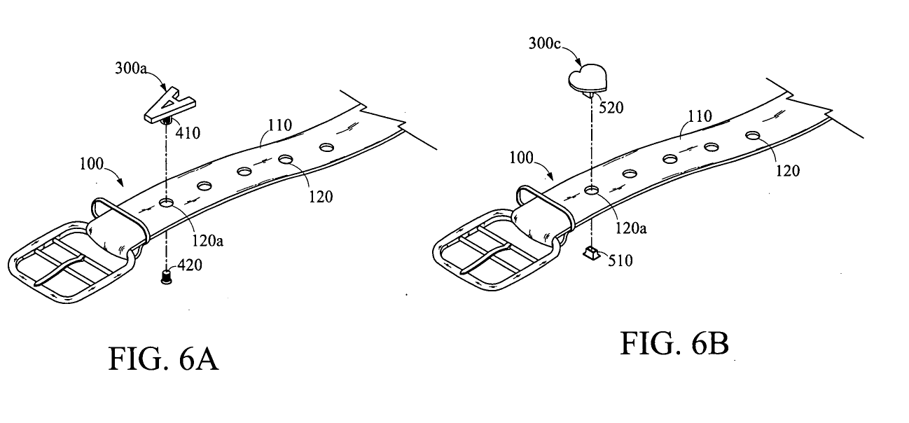

Referring now to FIG. 6A, a perspective view of the letter charm element 300a being attached to the harnessing member 100 for configuring the decorative harness 1000a (as show in FIG. 3A) is illustrated, according to an embodiment of the present invention. FIG. 6A will be described in conjunction with FIG. 5A. Specifically, FIG. 6A illustrates the letter charm element 300a is being attached to the strap element 110 of the harnessing member 100. For attaching the letter charm element 300a to the strap element 110, the female engagement element 410 is inserted into an engagement location 120a of the engagement locations 120 from an upper side of the strap element 110. Thereafter, the male engagement element 420 is inserted in the female engagement element 410 from an underside of the strap element 110 by a screwing motion, thereby securing the letter charm element 300a on the harnessing member 100. The thread lock compound of the male engagement element 420 provides extra security to keep the male engagement element 420 firmly secured in a place in the female engagement element 410. Further, the head portion 422 rests at the underside of the strap element 110. The head portion 422 is smooth, and does not irritate or cause pain to the skin or neck portion of the pet 2000, when the harnessing member 100 is worn by the pet 2000.

In a similar fashion, the letter charm element 300a having the attaching mechanism 400 may be secured to the leash member 200 for configuring the decorative leash 1000b (as shown in FIG. 3B).

Referring now to FIG. 6B, a perspective view of the design charm element 300c being attached to the harnessing member 100 for configuring the decorative harness 1000a (as shown in FIG. 3A) is illustrated, according to an embodiment of the present invention. FIG. 6B will be described in conjunction with FIG. 5B. Specifically, FIG. 6B illustrates the design charm element 300c being attached to the strap element 110 of the harnessing member 100. For attaching the design charm element 300c to the strap element 110, the male engagement element 520 is inserted into the engagement location 120a of the engagement locations 120 from the upper side of the strap element 110. Thereafter, the male engagement element 520 is inserted in the female engagement element 510 from the underside of the strap element 110, and press fitted therein, thereby securing the design charm element 300c on the harnessing member 100. Further, the head portion 512 of the female engagement element 510 rests at the underside of the strap element 110. The head portion 512 may be made smooth, thereby avoiding irritation or pain to the skin or neck portion of the pet 2000, when the harnessing member 1000 is worn by the pet 2000.

In a similar fashion, the design charm element 300c having the attaching mechanism 500 may be secured to the leash member 200 for configuring the decorative leash 1000b (as shown in FIG. 3B).

Attaching mechanisms, such as the attaching mechanism 400 and the attaching mechanism 500 of the each charm element as disclosed above, provide the each charm element to be secured onto the harnessing member 100 and the leash member 200 in a sturdy manner, thereby providing a decorative accessory, such as the decorative harness 1000a and the decorative leash 1000b.

Referring now to FIG. 7, a perspective view of a decorative harness 6000 to be worn by and/or used with a pet, such as a horse 7000, is illustrated. According to one embodiment of the present invention, the decorative harness 6000 includes a harnessing member (not numbered), and a plurality of charms, such as the charms 300 (as shown in FIGS. 2, and 4A to 4E). The plurality of charms is attached to the harnessing member by means of attaching mechanisms, such as the attaching mechanism 400 and the attaching mechanism 500. The attaching mechanism 400 and the attaching mechanism 500 have been explained with reference to FIGS. 5A and 5B, and accordingly description thereof is omitted here.

In the present embodiment, the harnessing member include the plurality of strap elements (as mentioned above), such as a nose strap element 602, a jaw strap element 604, a forehead strap element 606, a head strap element 608 and a brow band strap element 610. Each strap element, such as the nose strap element 602, the jaw strap element 604, the forehead strap element 606, the head strap element 608, and the brow band strap element 610, (hereinafter collectively referred to as the strap elements) include a plurality of engagement locations configured thereon. The plurality of engagement locations configured on the strap elements is similar to the engagement locations 120 (as shown in FIG. 2). Further, a fastening element, such as a fastening element 612, a fastening element 614, a fastening element 616, and a fastening element 618 is disposed on the each of the strap elements. The fastening element disposed on the each of the strap elements may be similar to the fastening element 130 (as shown in FIG. 2). Fastening element of respective strap element coupled to each other to configure the harnessing member that may be secured to a body portion of the horse 7000. More particularly, upon securing the harnessing member to the body portion of the horse 7000, the nose strap element 602 gets disposed at a nose portion of the horse 7000. Further, the jaw strap element 604 connected to the nose strap element 602 gets disposed at a jaw portion of the horse 7000. Similarly, the forehead strap element 606, the head strap element 608, and the brow band strap element 610 gets disposed at a head portion, a brow portion, and a neck portion of the horse 7000, respectively.

Similarly, the decorative harness 6000 of the present embodiment may be used and/or worn with other pets, such as a cat, a horse, a pig, a cow, a donkey, a mule, a camel, a llama, a buffalo, and a sheep. In an embodiment, the harness 6000 may take the form of a breast collar for livestock or other animals, and reins (not shown) attach to the harness 6000 in a manner similar to the leash 1000b-harness 1000a arrangement described above. In other embodiments, the harness may take the form of a halter, a lead rope, a headstall, a tiedown, or a noseband.

The present invention provides a decorative accessory, such as the decorative accessory 1000 for a pet, such as for a dog and a cat, which may offer following advantages. The decorative accessory is functional and stylish. A harnessing member and a leash member, such as the harnessing member 100 and the leash member 200, respectively, of the decorative accessory may incorporate different charm elements, such as the charm elements 300. The different charm elements are secured on the harnessing member and the leash member by attaching mechanisms, such as the attaching mechanism 400 and the attaching mechanism 500. The attaching mechanisms facilitate each charm element of the different charm elements to be secured on the harnessing member and the leash member in a sturdy manner. With such attaching mechanisms, risk of falling off of the each charm element is very minuscule even when the pet is scratching, playing, and swimming. Further, such attaching mechanisms are not easily unscrewed or pulled by children, thereby reducing a risk of the each charm element falling off to be lost or posing a choking hazard for the pets and children. Furthermore, a decorative harness, such as the decorative harness 1000a and 4000, and a decorative leash, such as the decorative leash 1000b with the different charm elements provide comfort to the pet, when used with the pet. Furthermore, pet owners with multiple pets may use the decorative harness and the decorative leash with the different charm elements to give each pet of the multiple pets, their own decorative accessory in order to make them easier to identify, if any number of pets from the multiple pets look similar. The decorative accessory allows the pet owners to identify their pets in any setting, such as a dog park. The decorative accessory allows the pet owners to easily identify their pets, in case, the pets are lost. Moreover, the decorative accessory provides visible evidence of status of the pet owner, and visible evidence of value of the pet.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A decorative accessory for a pet, the decorative accessory, comprising:
a harnessing member comprising at least one strap element, each strap element of the at least one strap element comprising:
a plurality of engagement locations configured on the each strap element, and
a fastening element disposed on the each strap element for securing the harnessing member to a body portion of the pet;
a leash member comprising a strip element having a first end segment and a second end segment, a plurality of engagement emplacements configured on the strip element between the first end segment and the second end segment, and a connecting element disposed at the first end segment for connecting the leash member with the harnessing member; and
a plurality of charm elements, each charm element of the plurality of charm elements having an attaching mechanism extending from an underside of the each charm element, wherein the attaching mechanism comprises a female engagement element and a male engagement element, the female engagement element and the male engagement element adapted to secure the each charm element to at least one of an engagement location of the plurality of engagement locations of the at least one strap element, and an engagement emplacement of the plurality of engagement emplacements of the strip element, thereby securing the each charm element of the plurality of charm elements on least one of the harnessing member and the leash member.

2. The decorative accessory of claim 1, wherein adjacent engagement locations of the plurality of engagement locations are spaced apart by a predetermined distance.

3. The decorative accessory of claim 1, wherein the fastening element comprises a fastening buckle.

4. The decorative accessory of claim 3, wherein the fastening element comprises a slack ring element disposed at the first end portion adjacent to the fastening buckle for incorporating the second end portion to prevent the second end portion from flapping.

5. The decorative accessory of claim 1, wherein adjacent engagement emplacements of the plurality of engagement emplacements are spaced apart by a predetermined distance.

6. The decorative accessory of claim 1, wherein the attaching mechanism is a screw type attaching mechanism having a threaded female engagement element and a threaded male engagement element, the threaded male engagement element inserted in the threaded female engagement by a screwing motion for securing the each charm element to the at least one of the harnessing member and the leash member.

7. The decorative accessory of claim 6, wherein the threaded male engagement element comprises a thread lock compound for securing the threaded male engagement element into the threaded female engagement element.

8. The decorative accessory of claim 1, wherein the attaching mechanism is a snap fit attaching mechanism having a snap fit female engagement element and a snap fit male engagement element for press fitting the snap fit male engagement element in the snap fit female engagement element for securing the each charm element to the at least one of the harnessing member and the leash member.

9. A decorative harness for being worn on a body portion of a pet, the decorative harness, comprising:
a harnessing member comprising at least one strap element, each strap element of the at least one strap element comprising
a plurality of engagement locations configured on the each strap element, and
a fastening element disposed on the each strap element for securing the harnessing member to a body portion of the pet; and
a plurality of charm elements, each charm element of the plurality of charm elements having an attaching mechanism extending from an underside of the each charm element, wherein the attaching mechanism comprises a female engagement element and a male engagement element, the female engagement element and the male engagement element adapted to secure the each charm element to an engagement location of the plurality of engagement locations of the at least one strap element, thereby securing the each charm element of the plurality of charm elements on the harnessing member.

10. The decorative harness of claim 9, wherein adjacent engagement locations of the plurality of engagement locations are spaced apart by a predetermined distance.

11. The decorative harness of claim 9, wherein the fastening element comprises a fastening buckle having at least two center bars.

12. The decorative harness of claim 11, wherein the fastening element comprises a slack ring element disposed at the first end portion adjacent to the fastening buckle for incorporating the second end portion to prevent the second end portion from flapping.

13. The decorative harness of claim 9, wherein the attaching mechanism is a screw type attaching mechanism having a threaded female engagement element and a threaded male engagement element, the threaded male engagement element inserted in the threaded female engagement by a screwing motion for securing the each charm element to the harnessing member.

14. The decorative harness of claim 13, wherein the threaded male engagement element comprises a thread lock compound for securing the threaded male engagement element into the threaded female engagement element.

15. The decorative harness of claim 9, wherein the attaching mechanism is a snap fit attaching mechanism having a snap fit female engagement element and a snap fit male engagement element for press fitting the snap fit male engagement element in the snap fit female engagement for securing the each charm element to the harnessing member.

16. A decorative leash for being connected to a harnessing member for retaining a pet, the decorative leash comprising:
a leash member comprising a strip element having a first end segment and a second end segment, a plurality of engagement emplacements configured on the strip element between the first end segment and the second end segment, and a connecting element disposed at the first end segment, wherein the connecting element is capable of connecting the leash member to the harnessing member for retaining the pet; and
a plurality of charm elements, each charm element of the plurality of charm elements having an attaching mechanism extending from an underside of the each charm element, wherein the attaching mechanism comprises a female engagement element and a male engagement element, the female engagement element and the male engagement element adapted to secure the each charm element to an engagement emplacement of the plurality of engagement emplacements of the strip element, thereby securing the each charm element of the plurality of charm elements on the leash member.

17. The decorative leash of claim 16, wherein adjacent engagement emplacements of the plurality of engagement emplacements are spaced apart by a predetermined distance.

18. The decorative leash of claim 16, wherein the attaching mechanism is a screw type attaching mechanism having a threaded female engagement element and a threaded male engagement element, the threaded male engagement element inserted in the threaded female engagement by a screwing motion for securing the each charm element to the leash member.

19. The decorative leash of claim 18, wherein the threaded male engagement element comprises a thread lock compound for securing the threaded male engagement element into the threaded female engagement element.

20. The decorative leash of claim 16, wherein the attaching mechanism is a snap fit attaching mechanism having a snap fit female engagement element and a snap fit male engagement element for press fitting the snap fit male engagement element in the snap fit female engagement for securing the each charm element to the leash member.
